(19) United States
(12) Patent Application Publication
(10) Pub. No.: US 2004/0254843 A1
(43) Pub. Date: Dec. 16, 2004

(54) Methods and systems for conducting e-commerce transactions

(76) Inventor: Robert A. Koch, Norcross, GA (US)

Correspondence Address: Scott P. Zimmerman, P.O. Box 3822, Cary, NC, 27519, US

(21) Appl. No.: 10/457,882

(22) Filed: Jun. 10, 2003

(51) Int. Cl. G06F 17/60

(52) U.S. Cl. 705/26; 705/27

(57) ABSTRACT

Methods and systems are disclosed for e-commerce ordering of products. One method processes a transaction between a client and a server via a communications network. The transaction comprises a request for a quantity of a product at a price. A stock status query is prioritized and executed at a priority level. The stock status query determines whether sufficient inventory of the product is available for shipment. If the inventory is insufficient, then processing of the transaction is interrupted and a notification is sent to the client of the insufficient inventory. The client may then elect to cancel the transaction, or, continue the transaction despite the insufficient inventory.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

1. Field of the Invention

This invention generally relates to computers and to computer networking and, more particularly, to methods and systems for conducting e-commerce transactions in a client-server environment.

2. Description of the Related Art

E-commerce companies often unnecessarily process transactions. When an end-user orders a product from a website, the website proprietor completely processes the transaction—that is, a credit card is charged, a shipping address is verified, and the order is processed for fulfillment. Hours, or even days later, the website proprietor may notify the end-user that the product is not in stock or that pricing has changed. Although the website proprietor has completely processed the transaction, the end-user is often dismayed to learn the product will not ship until inventory is replenished. The end-user is also infuriated to learn their credit card was charged at a higher-than-expected price. Had the end-user known, however, that the product was not in stock, or that pricing had changed, the end-user may not have wanted to continue the transaction. The end-user, instead, may have wished to cancel the transaction and shop another website proprietor. If the end-user was paying a per-minute charge for connection time (such as when connected to an airport's wireless network), the end-user may also have wished to cancel the transaction to avoid unnecessary connection charges. There is, accordingly, a need in the art for reducing unnecessary transaction processes, a need for verifying inventory before processing e-commerce transactions, and a need for verifying pricing before processing e-commerce transactions.

### BRIEF SUMMARY OF THE INVENTION

The aforementioned problems, and other problems, are reduced by a Middleware Manager. This Middleware Manager includes computer programs and computer systems that first verify inventory and pricing before completely processing an online, e-commerce order. Because online connection time often requires a per-minute charge, this invention first determines whether sufficient inventory exists to fulfill an online order. If inventory levels are insufficient, this invention suspends processing of the online order. An end-user, utilizing a client application at a client computer system, is then notified of the insufficient inventory. The end-user may then cancel the transaction or, instead, continue the transaction despite the insufficient inventory. This invention, then, reduces processing times by suspending unnecessary processing steps when insufficient inventory conditions exist.

This invention may also verify pricing of e-commerce transactions. When the end-user submits an e-commerce transaction, the invention then determines whether a pricing discrepancy exists. As those of ordinary skill in the art recognize, the client application may not have up-to-date price lists/information. This invention, therefore, determines whether a discrepancy exists between the price of the order and a current price for the product. If the pricing is incorrect, the Middleware Manager suspends processing the transaction and prompts the end-user to authorize payment at current price levels. The end-user, utilizing the client application at the client computer system, may then cancel the transaction or, instead, continue the transaction at current pricing. This invention, again, reduces processing times by suspending unnecessary processing steps when products are ordered at outdated pricing.

While this invention is applicable to any computer system and communications network, this invention is particularly useful for wireless networks. Wireless networks, such as those utilizing the I.E.E.E. 802 family of wireless standards, often require charges for each minute of connection—and these charges can be at premium rates. This invention reduces connection charges by allowing the end-user to completely configure an offline order—that is, while the client computer system is not communicating with the communications network. When the client computer system comes within range of the communications network (e.g., a “Wi-Fi” wireless network), this invention limits the charges incurred for online connection time. If inventory is insufficient to fulfill the order, and/or the client application has outdated pricing, then the Middleware Manager suspends processing of the transaction. The end-user has the option of canceling the transaction, or, continuing the transaction. Because the Middleware Manager prioritizes inventory and pricing queries, the Middleware Manager does not unnecessarily process the e-commerce transaction unless product can be shipped and payment can be authorized. These prioritized inventory and pricing queries allow the Middleware Manager to reduce online connection charges.

This invention discloses methods and systems for conducting an e-commerce transaction. One method processes a transaction between a client and a server via a communications network. The transaction comprises a request for a quantity of a product at a price. A stock status query is prioritized and executed at a priority level. The stock status query determines whether sufficient inventory of the product is available for shipment. If the inventory is insufficient, then processing of the transaction is suspended and a notification is sent to the client of the insufficient inventory. The client may then elect to cancel the transaction, or, continue processing the transaction despite the insufficient inventory.

Another embodiment of this invention describes another method for conducting an e-commerce transaction. Here an application is communicated from a server to a client via a communications network. The application comprises a component for configuring an order during an offline session of the client, and the order requests a quantity of a product at a price. A transaction is processed between the client and a server via the communications network, and the transaction comprises the order configured during the offline session of the client. The method prioritizes and executes at least one of a stock status query and a price query at a priority level. The stock status query determines whether sufficient inventory of the product is available for shipment, and the price query determines whether a discrepancy exists between the price of the order and a current price for the product. If the inventory is insufficient, then processing of the transaction is suspended. If the discrepancy exists, then processing of the transaction is suspended. A notification is then initiated to the client of at least one of i) the insufficient inventory and ii) the discrepancy between the price of the order and the current price for the product. The client may then elect to cancel the transaction, or, continue processing the transaction despite the insufficient inventory and/or the discrepancy in price.

### BRIEF DESCRIPTION OF THE SEVERAL VIEWS OF THE DRAWINGS

These and other features, aspects, and advantages of this invention are better understood when the following Detailed Description of the Invention is read with reference to the accompanying drawings, wherein:

FIGS. 1 and 2 are schematics illustrating one possible operating environment for an embodiment of this invention;

FIG. 3 is a schematic showing an alternative embodiment of this invention;

FIG. 4 is a schematic illustrating another embodiment of this invention;

FIG. 5 is a schematic illustrating another embodiment of this invention; and

FIG. 6 is a flowchart showing one method for conducting e-commerce transactions between a client computer and a server.

### DETAILED DESCRIPTION OF THE INVENTION

This invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

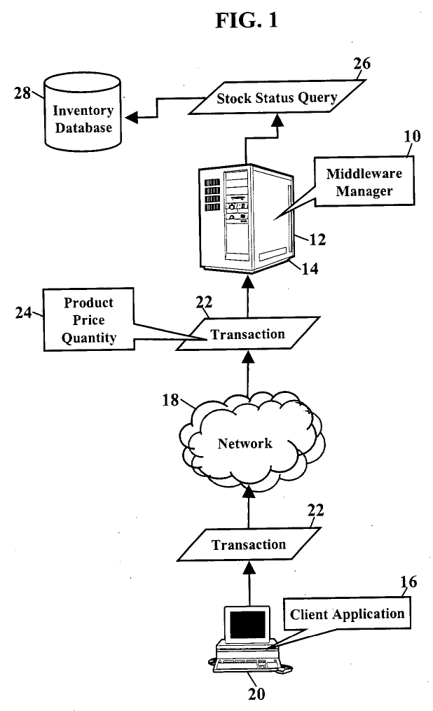

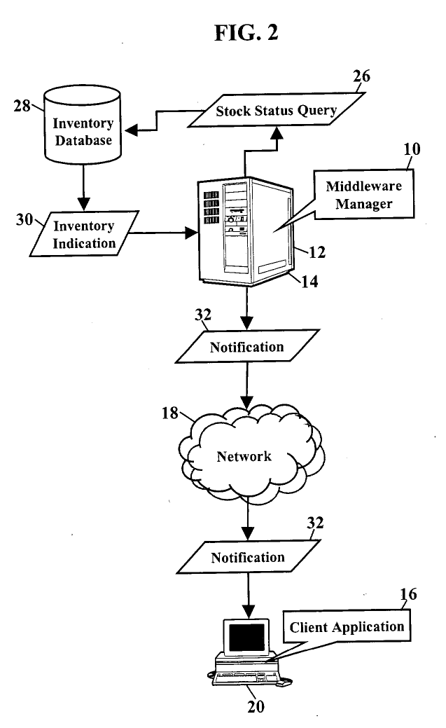

FIGS. 1 and 2 are schematics illustrating one possible operating environment for an embodiment of this invention. This embodiment of a Middleware Manager 10 includes computer programs and computer systems that first verify inventory and pricing before completely processing an online, e-commerce order. Because online connection time often requires a per-minute charge, this invention first determines whether sufficient inventory exists to fulfill an online order. If inventory levels are insufficient, this invention suspends processing of the online order to reduce connection charges. This invention then notifies a client application of the insufficient inventory. The client application may then cancel the transaction, or, continue the transaction despite the insufficient inventory. This invention, then, reduces processing times by suspending unnecessary processing when insufficient inventory conditions exist.

The Middleware Manager 10 mediates between “front end” and “back end” systems. As those of ordinary skill in the art understand, the term “middleware” generally describes any computer programming that links, or mediates, between two separate and usually already existing (or “legacy”) programs. A common application of middleware is to allow programs written for access to a particular database (such as DB2®) to access other databases (such as those databases utilizing the Virtual Storage Access Method (VSAM), the Information Management System (IMS), ORACLE® Database, or ADABAS™) without the need for custom coding. (DB2®, VSAM®, and IMS® are registered trademarks of the International Business Machines Corporation, ORACLE® is a registered trademark of the Oracle Corporation, and ADABAS™ is a registered trademark of Software, AG of Germany.) Middleware usually utilizes a common set of Application Programming Interfaces (API's) that client and server applications can invoke. Middleware is often considered the “plumbing” of an information system as data and information are transparently routed between different back-end data sources and end-user applications. The Middleware Manager 10, then, allows disparate systems to be joined together in a common framework.

FIG. 1 is a schematic showing the Middleware Manager 10 residing in a computer system 12. The computer system 12 is commonly a server 14, and the server 14 communicates with a client application 16 via a communications network 18 (such as a local-area network (LAN), a wide-area network (WAN) and/or a distributed computing network, such as the Internet). The client application 16 typically resides within a client computer system 20. As those of ordinary skill in the art recognize, the client-server relation describes a distributed computing system in which an application at one site sends a request to another application at another site. The requesting application is termed the “client,” while the responding application is the “server.” Although the client-server relation may utilize any means of communicating data between the client and the server, the standard Transmission Control Protocol/Internet Protocol (TCP/IP) is preferably utilized to send packetized messages via the distributed computing network 18. Because communication via the communications network 18 is often bi-directional, the terms “client” and “server” may, however, apply to both the Middleware Manager 10 and the client application 16. Because the client-server relation is well-understood by those of ordinary skill in the art of computing, the client-server relation will not be further explained.

The Middleware Manager 10 processes a transaction 22 between the client 16, 20 and the server 14. The transaction 22 is communicated from the client computer system 20 to the server 14 via the communications network 18. The transaction 22 commonly comprises a request 24 for a quantity of a product at a price. The transaction 22 and/or the request 24 may sometimes be termed an “order.” The Middleware Manager 10 receives the transaction 22 and/or the request 24 and prioritizes a stock status query 26. The stock status query 26 determines whether sufficient inventory of the product is available for shipment. The Middleware Manager 10 preferably queries an inventory database 28 to determine whether sufficient inventory exists to fulfill the desired quantity. The inventory database 28 typically maintains an inventory account for the product. The inventory database 28 is preferably a real-time, or nearly real-time, indication of inventory. The inventory database 28 typically sets flags to indicate whether sufficient inventory exists to fulfill the request 24. The inventory database 28, however, may utilize any means for indicating whether sufficient inventory of the product is available for shipment.

The Middleware Manager 10 executes the stock status query 26 at a priority level. That is, the Middleware Manager 10 first verifies whether sufficient inventory is available before completely processing an online, e-commerce order. The stock status query 26 takes precedence over other lesser important queries and processing. The objective is to quickly ascertain inventory to determine whether further processing of the transaction is necessary or desirable. The stock status query 26, then, is preferably executed at a high priority or urgent level.

FIG. 2 is a schematic further illustrating the systems and methods of this invention. The Middleware Manager 10 prioritizes and issues the stock status query 26. The inventory database 28 receives the stock status query 26 and returns an inventory indication 30. The Middleware Manager 10 receives the inventory indication 30 and decides whether to continue processing the transaction (shown as reference numeral 22 in FIG. 1). As FIG. 2 shows, if inventory levels are insufficient, the Middleware Manager 10 suspends processing of the transaction and initiates a notification 32. The notification 32 is communicated to the client application 16 via the communications network 18. The notification 32 informs the client application 16 of the insufficient inventory. The client application 16 may then cancel the transaction, or, continue the transaction despite the insufficient inventory. If the end-user chooses to continue with the transaction, the Middleware Manager 10 resumes processing the transaction. The Middleware Manager 10, for example, may authorize payment (e.g., process payment utilizing a credit card account number or debit an account) and/or verify a shipping address. The Middleware Manager 10 may also communicate a confirmation of the transaction.

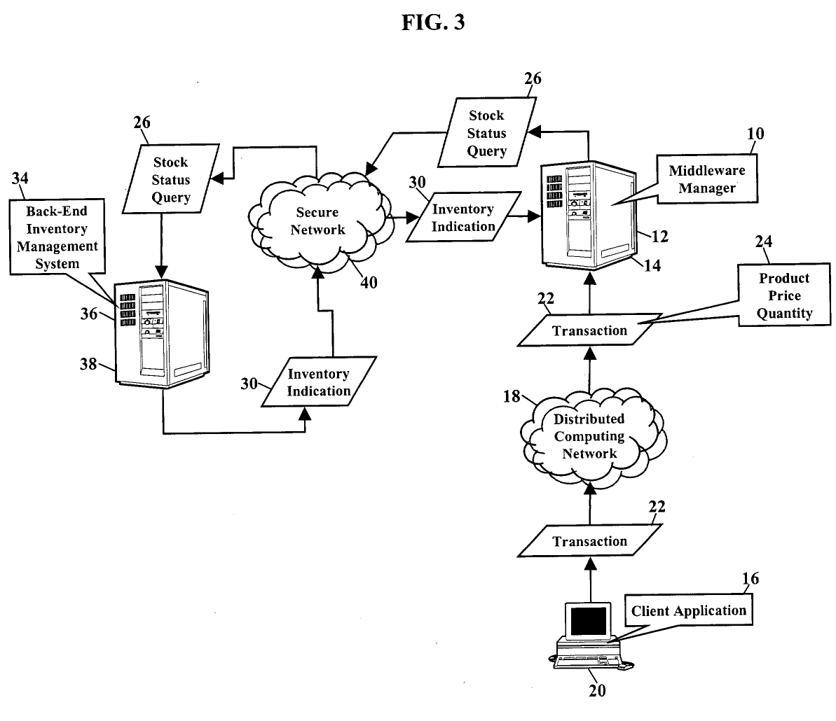

FIG. 3 is a schematic showing an alternative embodiment of this invention. Here the Middleware Manager 10 queries a back-end inventory management system 34. As those of ordinary skill in the art recognize, the back-end inventory management system 34 is a computer program that determines whether sufficient inventory exists to fulfill the transaction 22. The back-end inventory management system 34 typically resides within another computer system 36, such as another server 38. The back-end inventory management system 34 may itself communicate with remote warehousing and/or distribution centers to determine whether sufficient inventory exists. The Middleware Manager 10, as explained before, mediates between the end-user client application 16 and the back-end inventory management system 34. The Middleware Manager 10 creates, formats, and prioritizes the stock status query 26. The stock status query 26 is communicated via a secure communications network 40 to the back-end inventory management system 34. The secure communications network 40 is typically a secure local-area network (LAN) or a secure wide-area network (WAN), however, the secure computing network 40 may also comprise a distributed computing network, such as the Internet. The back-end inventory management system 34 then determines whether sufficient inventory of the product is available for shipment. The back-end inventory management system 34 returns the inventory indication 30 via the secure communications network 40.

The Middleware Manager 10 receives the inventory indication 30 and decides whether to continue processing the transaction 22. If inventory levels are insufficient, the Middleware Manager 10 suspends processing of the transaction 22 and initiates the notification (shown as reference numeral 32 in FIG. 2). The notification is communicated to the client application 16 via the communications network 18. The notification informs the client application 16 of the insufficient inventory. The end-user, using the client application 16, may then cancel the transaction, or, continue the transaction despite the insufficient inventory. If the end-user chooses to continue with the transaction, the Middleware Manager 10 resumes processing the transaction, such as by authorizing payment, verifying a shipping address, and/or communicating a confirmation of the transaction.

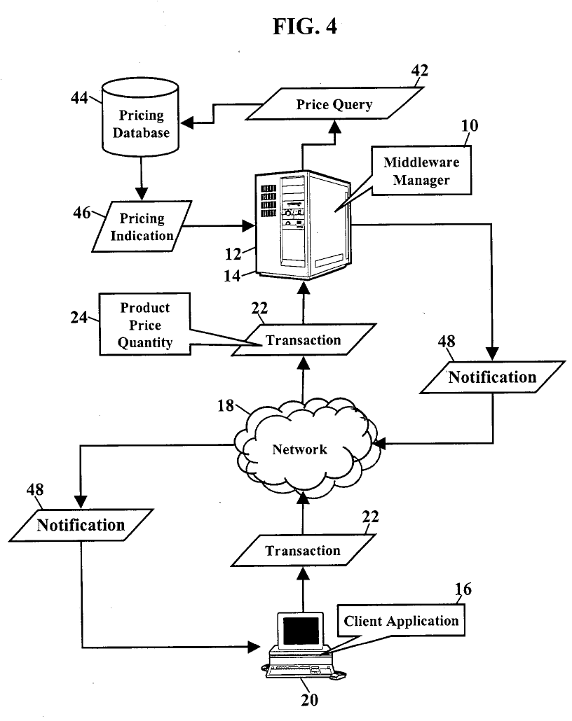

FIG. 4 is a schematic illustrating another embodiment of this invention. Here the Middleware Manager 10 prioritizes a price query 42. The price query 42 determines whether a discrepancy exists between the price of the request 24 and a current price for the product. As those of ordinary skill in the art recognize, the client application 16 may not have up-to-date price lists/information. If the pricing is incorrect, the Middleware Manager 10 suspends processing the transaction 22 and prompts the end-user to authorize payment at current price levels.

FIG. 4 shows the price query 42. The Middleware Manager 10 receives the transaction 22 via the communications network 18. The transaction 22 comprises the request 24 for a quantity of a product at a price. The Middleware Manager 10 receives the transaction 22 and/or the request 24 and prioritizes the price query 42. The Middleware Manager 10 executes the price query 42 at a priority level to quickly determine whether a discrepancy exists between the price of the request 24 and a current price for the product. If a discrepancy exists, further processing of the transaction may not be necessary or desirable. The price query 42, then, is preferably executed at a high priority or urgent level. The Middleware Manager 10 preferably queries a pricing database 44 that stores current pricing for products. The pricing database 44 receives the price query 42 and returns a pricing indication 46. The Middleware Manager 10 receives the pricing indication 46 and decides whether to continue processing the transaction 22. If the discrepancy exists, the Middleware Manager 10 suspends processing of the transaction 22 and initiates another notification 48. This notification 48 is communicated to the client application 16 via the communications network 18. The notification 48 informs the client application 16 of the discrepancy in price. The end-user, using the client application 16, may then cancel the transaction 22, or, continue the transaction 22 at the current price. If the end-user chooses to continue with the transaction 22, the Middleware Manager 10 resumes processing the transaction 22, such as by authorizing payment, verifying a shipping address, and/or communicating a confirmation of the transaction 22.

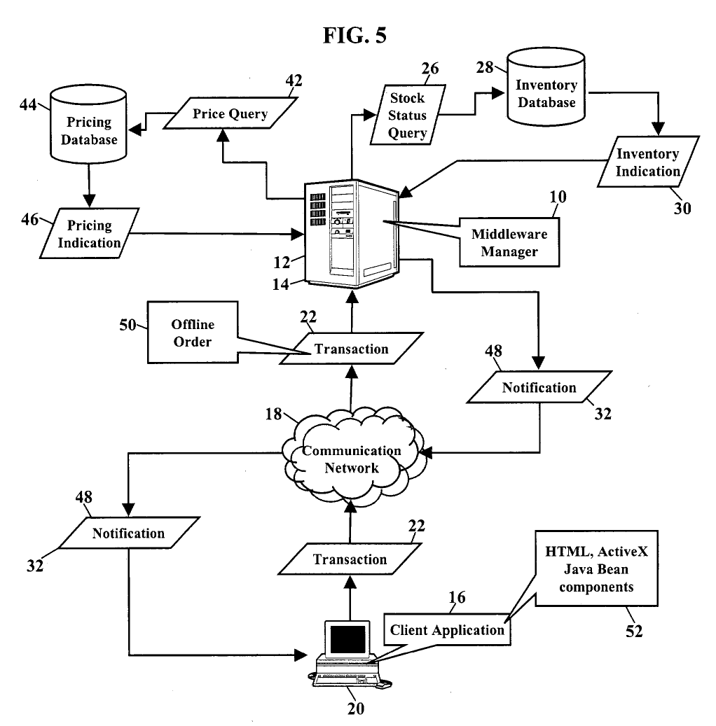

FIG. 5 is a schematic illustrating another embodiment of this invention. Here the transaction 22 comprises an offline order 50. The offline order 50 was created/formatted/configured by the client application 16 during an offline session. Because online connection charges can be expensive, the client application 16 comprises one or more components for configuring the offline order 50 during an offline session. The client application 16 is downloaded to the client computer system 20 via the communications network 18. The client application 16 is stored in a memory of the client computer system 20, and the client application 16 facilitates offline shopping and offline ordering. The end-user may use the client application 16 to browse, navigate, and order products from a product catalog stored in memory.

The offline order 50 is configured during an offline session. Although the client computer system 20 may not be communicating with the communications network 18, the client application 16 may still configure the offline order 50. When a connection to the communications network 18 is available, the client application 16 then submits the offline order 50. The client application 16 comprises one or more components 52 for configuring the offline order 50 during the offline session. These components 52 may include any programming that facilitates configuring the offline order 50. These components 52 may comprise, for example, HyperText Markup Language (HTML), ACTIVEX® controls, and/or JAVA® Beans. (ACTIVEX® is a registered trademark of Microsoft Corporation, One Microsoft Way, Redmond Wash. 98052-6399, 425.882.8080, www.microsoft.com, and JAVA® is a registered trademark of Sun Microsystems, Inc., 901 San Antonio Road, Palo Alto Calif. 94303, www.sun.com). As those of ordinary skill understand, ACTIVEX® is a set of technologies from Microsoft that enables interactive content for the World Wide Web. As those of ordinary skill also understand, a JAVA® Bean is a reusable software component that can be visually manipulated in builder tools. These reusable components add standardized interfaces and object introspection mechanisms that allow builder tools to query components about their properties and behavior. These components 52, whether HTML, ACTIVEX® controls, JAVA® Beans, and/or other programming, allow the client application 16 to configure the offline order 50 and, then, submit the offline order 50 when a connection to the communications network 18 is available.

When the connection is available, the Middleware Manager 10 receives the transaction 22 via the communications network 18. The transaction 22 comprises the offline order 52 configured during the offline session of the client application 16, and the offline order 52, as before, requests a quantity of a product at a price. The Middleware Manager 10 prioritizes one, or both, of the stock status query 26 and the price query 42. The Middleware Manager 10, then, executes one or both of the stock status query 26 and/or the price query 42 at a priority level. If the inventory is insufficient, then the Middleware Manager 10 suspends the processing of the transaction 22. If a price discrepancy exists, then the Middleware Manager 10 suspends the processing of the transaction 22. The Middleware Manager 10 initiates the notification 32 and/or 48 to the client computer system 20, executing the client application 16, of either i) the insufficient inventory and/or ii) the discrepancy between the price of the order and the current price for the product. The end-user, using the client application 16, may then cancel the transaction 22, or, continue the transaction 22. If the end-user chooses to continue with the transaction 22, the Middleware Manager 10 resumes processing the transaction 22, such as by authorizing payment, verifying a shipping address, and/or communicating a confirmation of the transaction 22.

While the embodiment shown in FIG. 5 is applicable to any environment, this embodiment is particularly useful for wireless networks. This invention limits online connection times and, thus, reduces online connection charges. Wireless networks, such as those utilizing the I.E.E.E. 802 family of wireless standards, are becoming more common in airports, business service centers, and even shopping malls and restaurants. These wireless networks, however, often require charges for each minute of connection, and these charges can be at premium rates. The embodiment of FIG. 5 allows the end-user to completely configure the offline order 52 while the client computer system 20 (shown as a mobile, or laptop, computer) is offline—that is, not communicating with the communications network 18. When the client computer system 20 comes within range of a wireless network (e.g., a “Wi-Fi” network), this invention limits the charges incurred for online connection time. If inventory is insufficient to fulfill the order, and/or the client application 16 has outdated pricing, then the Middleware Manager 10 suspends processing of the transaction 22. The end-user, using the client application 16, may then cancel the transaction 22, or, continue the transaction 22. Because the Middleware Manager 10 prioritizes inventory and pricing queries, the Middleware Manager 10 does not unnecessarily process the transaction 22 unless product can be shipped and payment can be authorized. These prioritized inventory and pricing queries allow the Middleware Manager 10 to reduce online connection charges.

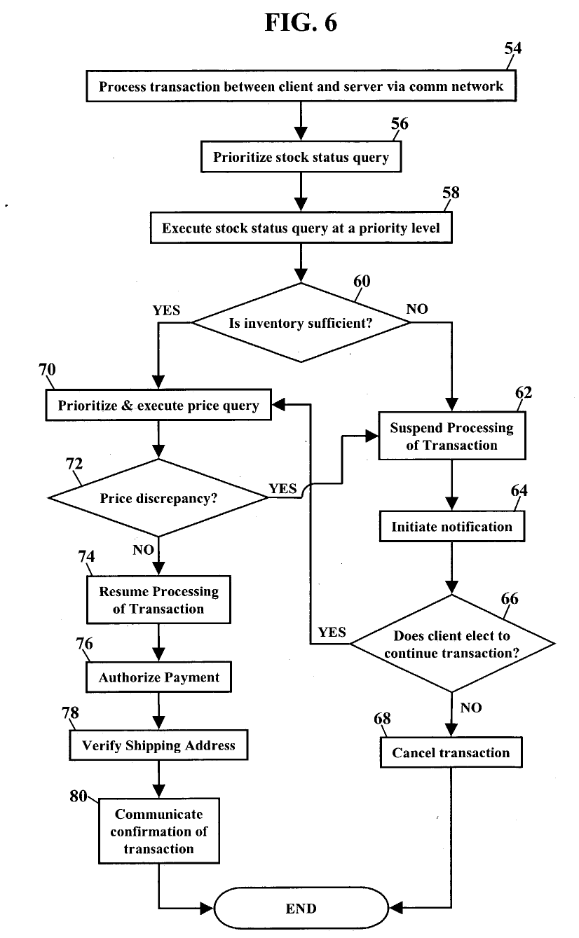

FIG. 6 is a flowchart showing one method for conducting e-commerce transactions between a client computer and a server. The method processes the transaction between the client and the server via a communications network (Block 54). The transaction comprises a request for a quantity of a product at a price. A stock status query is prioritized (Block 56) and executed at a priority level (Block 58). The stock status query determines whether sufficient inventory of the product is available for shipment. If the inventory is insufficient (Block 60), then processing of the transaction is suspended (Block 62) and a notification to the client of the insufficient inventory is initiated (Block 64). The notification may comprise prompting the client/end-user to continue processing the transaction despite the insufficient inventory (Block 66), or, prompting the client/end-user to cancel the transaction (Block 68). If the inventory is sufficient (Block 60), or if the client/end-user elects to continue processing the transaction despite the insufficient inventory (Block 66), then a price query is prioritized and executed (Block 70). The price query determines whether a discrepancy exists between the price of the request and a current price for the product.

If the discrepancy exists (Block 72), then processing of the transaction is suspended (Block 62). A notification to the client of the insufficient inventory is initiated (Block 64). The notification may comprise prompting the client/end-user to continue the transaction 22 at the current price (Block 66), or, prompting the client/end-user to cancel the transaction (Block 68). If no price discrepancy exists (Block 72), or if the client/end-user elects to continue processing the transaction (Block 66), processing of the transaction is resumed (Block 70). Because processing was resumed, payment is authorized (Block 76), a shipping address is verified (Block 78), and a confirmation of the transaction is communicated (Block 80).

As FIGS. 1-5 show, the Middleware Manager (shown as reference numeral 10 in FIGS. 1-5) may reside in the computer system 12. The Middleware Manager operates within a system memory device, such as a memory subsystem, flash memory, and/or peripheral storage device. The computer system 12 has one or more central processors executing an operating system, a graphics subsystem, the memory subsystem, Peripheral Bus Controller, and a PCI (Peripheral Controller Interface) bus. The Peripheral Bus Controller serves as an input/output hub for various peripheral ports, such as a keyboard port, a mouse port, a serial port and/or a parallel port for a video display unit, one or more external device ports, and networking ports (such as SCSI or Ethernet). The Peripheral Bus Controller could also include an audio subsystem. Those of ordinary skill in the art understand that the program, processes, methods, and systems described in this patent are not limited to any particular computer system or computer hardware.

The Middleware Manager (shown as reference numeral 10 in FIGS. 1-5) may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the Middleware Manager to be easily disseminated. A computer program product for conducting e-commerce transactions comprises the computer-readable medium and the Middleware Manager. The Middleware Manager is stored on the computer-readable medium.

The Middleware Manager may also be physically embodied on or in any addressable (e.g., HTTP, I.E.E.E. 802.11, Wireless Application Protocol (WAP)) wireless device capable of presenting an IP address. Examples could include a computer, a wireless personal digital assistant (PDA), an Internet Protocol mobile phone, or a wireless pager.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A method, comprising:
processing a transaction between a client and a server via a communications network, the transaction comprising a request for a quantity of a product at a price;
prioritizing a stock status query;
executing the stock status query at a priority level, the stock status query determining whether sufficient inventory of the product is available for shipment;
if the inventory is insufficient, then suspending the processing of the transaction; and
initiating a notification to the client of the insufficient inventory.

2. A method according to claim 1, wherein the step of initiating the notification to the client comprises prompting the client to continue processing the transaction despite the insufficient inventory.

3. A method according to claim 1, wherein the step of initiating the notification to the client comprises prompting the client to cancel the transaction.

4. A method according to claim 1, further comprising resuming processing the transaction if the inventory is sufficient.

5. A method according to claim 4, further comprising authorizing payment.

6. A method according to claim 4, further comprising verifying a shipping address.

7. A method according to claim 4, further comprising communicating a confirmation of the transaction.

8. A method according to claim 1, further comprising prioritizing a price query.

9. A method according to claim 8, further comprising executing the price query at another priority level, the price query determining whether a discrepancy exists between the price of the request and a current price for the product.

10. A method according to claim 9, wherein if the discrepancy exists between the price of the request and the current price, then suspending processing of the transaction.

11. A method according to claim 10, further comprising initiating another notification to the client of the discrepancy between the price of the request and the current price.

12. A method according to claim 11, wherein the step of initiating the other notification to the client comprises prompting the client to continue processing the transaction at the current price.

13. A method according to claim 11, wherein the step of initiating the other notification to the client comprises prompting the client to cancel the transaction.

14. A method according to claim 9, further comprising resuming processing the transaction if no discrepancy exists.

15. A method, comprising:
communicating an application from a server to a client via a communications network, the application comprising a component for configuring an order during an offline session of the client, the order requesting a quantity of a product at a price;
processing a transaction between the client and a server via the communications network, the transaction comprising the order configured during the offline session of the client;
prioritizing at least one of a stock status query and a price query;
executing at least one of the stock status query and the price query at a priority level, the stock status query determining whether sufficient inventory of the product is available for shipment, and the price query determining whether a discrepancy exists between the price of the order and a current price for the product;
if the inventory is insufficient, then suspending the processing of the transaction;
if the discrepancy exists, then suspending the processing of the transaction; and
initiating a notification to the client of at least one of i) the insufficient inventory and ii) the discrepancy between the price of the order and the current price for the product.

16. A method according to claim 15, wherein the step of initiating the notification to the client comprises prompting the client to continue processing the transaction.

17. A method according to claim 15, wherein the step of initiating the notification to the client comprises prompting the client to cancel the transaction.

18. A method according to claim 15, further comprising resuming processing the transaction if at least one or i) the inventory is sufficient and ii) no discrepancy exists.
